(19) United States
(12) Patent Application Publication
(10) Pub. No.: US 2011/0315546 A1
(43) Pub. Date: Dec. 29, 2011

(54) APPARATUS FOR PRODUCING AND DISPENSING HYDROGEN

(75) Inventor: Jean-François Geneste, Toulouse (FR)

(73) Assignee: ASTRIUM SAS, Paris (FR)

(21) Appl. No.: 13/255,167

(22) PCT Filed: Mar. 10, 2010
(86) PCT No.: PCT/FR2010/050410

§ 371 Date: Sep. 7, 2011

(30) Foreign Application Priority Data
Mar. 24, 2009 (FR) 0901369

(51) Int. Cl. C25B 15/08; G05D 1/10; G05D 1/12; C25B 9/00

(52) U.S. Cl. 204/262; 204/263; 244/175

(57) ABSTRACT

The present disclosure relates to an altitude-adjustable apparatus comprising: a platform; a device for controllably raising the altitude of the platform; a water supply combined with said platform; a device for converting water into the components thereof through solar power; and means for liquefying and storing the resulting liquefied hydrogen in tanks, the latter being built into flying bodies that are designed to arrive at a target area and dispense the liquefied hydrogen.

### CROSS-REFERENCE TO RELATED APPLICATIONS

This is a national phase application under 35 U.S.C. §371 of PCT Application No. PCT/FR2010/050410, filed Mar. 10, 2010, which claims the benefit of French application No. 09/01369 filed Mar. 24, 2009, the contents of which are expressly incorporated herein by reference.

### FIELD OF ART

The present disclosure relates to an apparatus for producing and dispensing hydrogen from water submitted to the action of sun radiation.

### BACKGROUND

It is known that, considering that hydrocarbon fossil earth resources will be exhausted within a few tens of years, different power alternatives are developed, even already used, for replacing them. This is, for instance, the case with hydrogen being considered as a <<clean>> fuel and which would advantageously be used as fuel cells for the transport industry or, in general, as a source of electric power.

However, people are then faced with the problem of the production of hydrogen and of the source of power allowing to obtain it, as, currently, it is mainly produced from naturally occurring gas, and, as known, there too, the supplies are poor, generating in addition an environment nuisance as a result of the emission of CO₂.

However, from document US 2008/0053094, an apparatus is already known for producing electric power from sun radiation by means of appropriate apparatus; such an apparatus is mounted on a vehicle of the aerostat type, being located in the high atmosphere. Thereby, the electric power being produced can be used for supplying equipment and auxiliary devices provided on board the vehicle, in particular by means of a thermal engine receiving, for the operation thereof, the hydrogen and oxygen components obtained through electrolysis.

Thus, in this known apparatus, the hydrogen being produced is consumed on the site in said engine.

### SUMMARY

The aim of the present method, system and device is to allow for dispensing hydrogen outside the apparatus while preventing from generating nuisance to the environment.

To this end, the apparatus for producing and dispensing hydrogen from water submitted to the action of the sun radiation, of the type arranged in altitude, above the cloud layers, and comprising:
a platform;
a controllable sustaining device for said platform in altitude for carrying out the different lifting, descent and level putting phases of the latter;
a water supply associated with said platform;
a device for converting water into its hydrogen and oxygen components, from sun power being received and arranged on said platform; and
means for processing and storing the obtained hydrogen, provided on said platform, is remarkable, according to the present method, system and device, in that said means for processing and storing hydrogen comprise a liquefying equipment and tanks containing liquefied hydrogen and in that said tanks of liquefied hydrogen are integrated to flying bodies removably fastened to said platform and designed for reaching a target area so as to dispense the liquefied hydrogen contained in said tanks.

Thus, an apparatus is made, that not only produces hydrogen from the sun radiation, storing it in a liquefied shape in the appropriate tanks, but that still provides the dispensing thereof to useful areas, which could be, for instance, storing vessels located on the ground or even flying aircrafts, such as airplanes, for instance, operating with hydrogen.

For instance, said controllable sustaining device is of the balloon type and can comprise at least one gas envelope with an adjustable varying volume for providing the different operational phases of said platform.

Preferably, said gas envelope has an O-ring shape so as to be arranged on the periphery of said platform. The technically simple and reliable achievement of the device for sustaining the platform should thus be noticed.

Advantageously, said gas envelope is filled by part of the hydrogen being produced in situ by said converting device so that the whole apparatus relies on hydrogen becoming the primary resource therefor. However, said gas envelope could be filled with another gas, such as helium.

In a first embodiment, said device for converting water is of the cracking type spontaneously dissociating hydrogen from water and comprises at least one sun concentrator supplying the power necessary to such a conversion and mounted mobile on said platform so as to constantly and perpendicularly receive sun radiation. Thus, through the optimum orientation of one parabolic mirror (or more) as sun concentrator, the generated heat allows to perform the reaction necessary for water cracking and to collect the thus separated hydrogen and oxygen.

In a second embodiment, said water converting device is of the conversion type for the heat emitted by sun radiation into current for achieving the electrolysis of the water in said supply.

According to a first example, said water converting device operating through electrolysis could comprise at least one photovoltaic generator mounted mobile on said platform with an automatic orientation in the direction of the sun, perpendicularly to the radiation thereof.

According to a second example, said water converting device operating through electrolysis could comprise at least one thermal engine. The current obtained therefrom is then used for electrolysis. Advantageously, to said thermal engine a sun concentrator is associated being oriented in a continuous and automatic way in the direction of the sun, and in the focus of which said engine is located, so as to provide its supply with power. In particular, said thermal engine is a Stirling engine or a thermo-acoustic engine.

Advantageously, said liquefied hydrogen tanks are arranged under said platform so as to be protected from sun radiation. However, they could be arranged on said platform and protected from sun radiation by a mask forming equipment and generating shadow. In addition, using flying bodies prevents from putting the platform down on the ground for emptying the hydrogen tanks should the latter be transferred in storing vessels.

Said flying bodies could be drones carrying out their descent phase to the target area by gliding, with a terminal guidance equipment towards said target area, and their lifting phase back to said platform through being propelled by an engine provided in each one of them and operating with hydrogen.

Furthermore, said apparatus comprises, in addition, a device for controlling the attitude and the position of said platform being located in the atmosphere so as to keep under control the possible motions of the apparatus submitted to the winds. Preferably, the apparatus further comprises equipment for collecting water particles from the clouds, so as to fill said water supply.

Such equipment could have the shape of a tight mesh net so as to trap said water particles.

Thereby, it is optionally no longer needed to put the apparatus down on the ground for filling its supply.

Furthermore, said apparatus could comprise means for processing and storing oxygen obtained through dissociation of water into its components, said means comprising at least one liquefying equipment and tanks containing the liquefied oxygen.

### BRIEF DESCRIPTION OF THE FIGURES

The figures of the appended drawing will help to better understand how the present method. system and device could be achieved. In these figures, like reference numerals relate to like components.

FIG. 1 is a very schematic perspective view of an embodiment of the apparatus according to the present method, system and device.

FIG. 2 is a bottom view of the platform of the apparatus shown on FIG. 1.

FIG. 3 is a schematic view showing how dispensing hydrogen produced by said apparatus.

### DETAILED DESCRIPTION

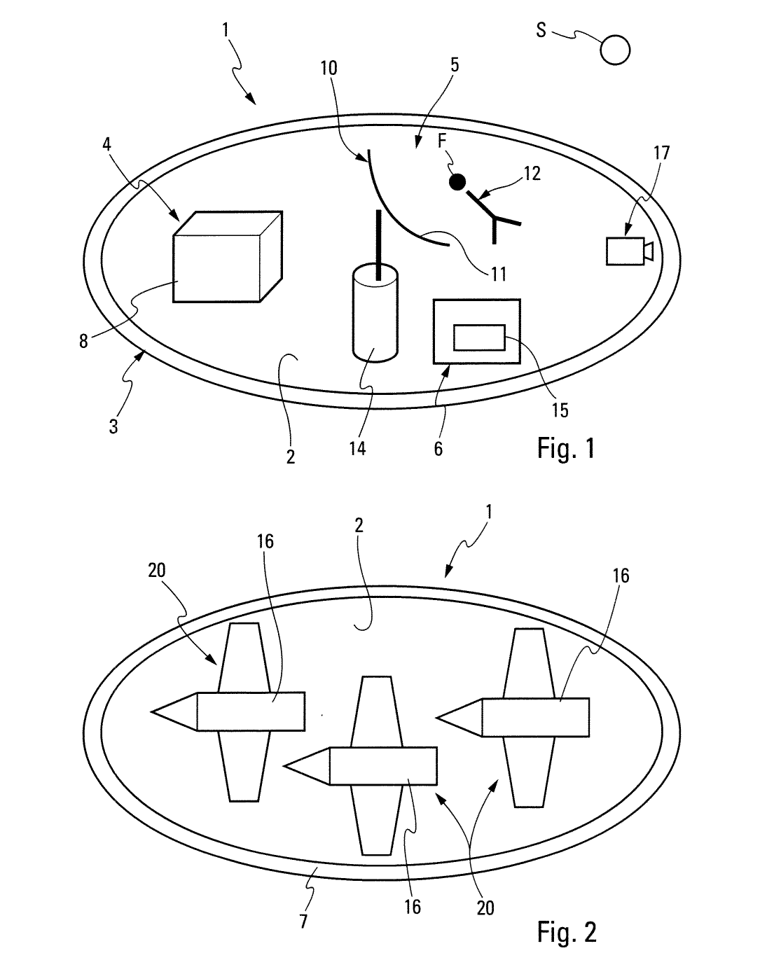

The hydrogen producing and dispensing apparatus 1 being shown very schematically on FIGS. 1 and 2 is, in its entirety, arranged in altitude, for instance in the stratosphere, at an altitude of about 30 kilometres, above the cloud layers so as to be directly exposed to sun radiation.

Structurally, the apparatus mainly comprises:
a platform 2;
a controllable sustaining device 3 for the platform in altitude, allowing the latter to lift, to descent and to be level put at the desired altitude;
water supply 4 arranged on the platform
a device 5 for converting water into its hydrogen and oxygen components, from sun power received through the radiation; and means 6 for processing and storing the hydrogen being obtained.

The platform 2 is made in a material or an appropriate combination of materials having the physicochemical properties necessary for being parked in such a hostile environment (temperature, radiation, etc.).

The controllable sustaining device 3 is of the inflatable balloon type with a settable gas volume, having, in this embodiment, the shape of an envelope or an O-ring 7 provided around the periphery being, for instance, circular of the platform 2, which prevents shadow areas on the platform. However, using usual balloons distributed around the platform is possible.

Through setting the internal gas volume in the O-ring envelope 7, the different operational phases of the platform are achieved, such as, including lifting, descending, either partially or completely, as will be explained hereinafter, level putting at the desired altitude. The gas contained in the envelope 7 will preferably be part of the hydrogen produced in situ by the apparatus, which avoids to take on board a supply of helium or of another gas if this is selected In addition, this imparts to the apparatus 1 a nearly unlimited autonomy (rather as a result of the equipment servicing and maintenance operations).

The water supply 4 is schematized in the shape of a parallelepipedic tank 8 arranged on the platform and containing the on-board water to be dissociated into its components.

As far as the water converting device 5 is concerned, it is for instance of the type through conversion of heat emitted by sun radiation into current, then being used for electrolysis of water, and such a conversion could be achieved from a photovoltaic generator (usual sun panel) and/or from a thermal engine, in particular a Stirling engine or a thermo-acoustic engine.

In the example illustrated on the schematic FIG. 1, the conversion device 5 comprises a sun concentrator 10 with a parabolic mirror 11 at the focus of which the hot source (piston) of a Stirling engine 12 is located, being heated by sun power concentrated at the focus of the parabola. More particularly, the parabolic mirror 11 is controlled by a motive device 14, allowing it to continuously and automatically follow the sun while being thereby oriented perpendicularly to the latter, so as to maximize the received sun power concentrated at the focus. The Stirling engine 12 thereby provides the conversion of sun power into current, which is then used for electrolyzing water contained in the supply 4 into its hydrogen and oxygen components. Naturally, in practice, there could be several sun concentrators with which as many engines are associated.

Instead of the Stirling engine, a thermo-acoustic engine could be used.

The water converting device 5 could be, according to another example, of the direct water cracking type, which in some conditions of temperature occurs spontaneously to produce hydrogen and oxygen. Such a conversion device, although it is not shown, as being close to the above mentioned sun concentrator example, then comprises one or more sun concentrators in the shape of parabolic mirrors, supplying the necessary heat for developing the reaction. There too, the concentrator(s) is or are motorized so as to be constantly oriented towards the sun.

In these two examples, additives could be added to water so as to increase the yield of the electrolysis and to heat water so as to further reduce the dissociation level of the water into its hydrogen and oxygen components.

The hydrogen being obtained from the conversion of water through electrolysis or through cracking according to the conversion mode to be used is processed and stored by specific means designated by 6 on the platform 2. Briefly, the collected hydrogen is first stored passively positioning for instance the production in the sun shadow, using a screen device, not shown, located on the platform and taking into account the conditions of temperature at this altitude. Then, by means of a cooling system 15 integrated into the processing means 6, the hydrogen is cooled down so as to be liquefied and the thus liquefied hydrogen is stored in tanks 16 being on board the platform and being preferably positioned under the latter so as to be in the shadow.

Advantageously, the hydrogen cooling system 15 operates with part of the current produced by the conversion device, such as Stirling engines.

Furthermore, an attitude and position controlling device is provided on the platform so as to be able to rotate it to compensate for its possible drift that could be due to the winds. This device designated by 17 on FIG. 1 could be of the nozzle or the helix type, thanks to which the apparatus can be stabilized in position and able to operate with part of the obtained hydrogen.

When the supply 4 is empty, the water supply can occur, in a first case, through completely descending the apparatus 1 by acting, to this end, on the settable O-ring envelope 7 of the sustaining device 3, until it reaches the ground on a target area, such as a natural or artificial lake, for filling the supply, then lifting the thus filled apparatus 1 back to the desired altitude in the high atmosphere.

In a second case, the apparatus 1 partially descends so as to reach thick cloud layers and, with the help of an appropriate collecting device, not shown, such as a large tight mesh net, so as to trap and recover steam from the clouds and thereby fill the water supply for climbing again afterwards at the desired altitude.

As far as the liquefied hydrogen tanks 16 are concerned, arranged under the platform, two dispensing modes for liquefied hydrogen could be contemplated.

In the first mode, when the tanks 16 are full, the platform of the apparatus is controlled so as to descend down to the ground through the action of the settable O-ring envelope and to set down on a target area for emptying the liquefied hydrogen tanks. During this phase, of course, servicing and maintenance operations of the different pieces of equipment of the apparatus could be carried out, as well as filling the water supply.

For information, the oxygen resulting from the dissociation of water is also stored and cooled down by not shown appropriate means, so that the, preferably liquefied, oxygen contained in tanks is also tapped when the apparatus is on the target area for being transferred to appropriate receptacles.

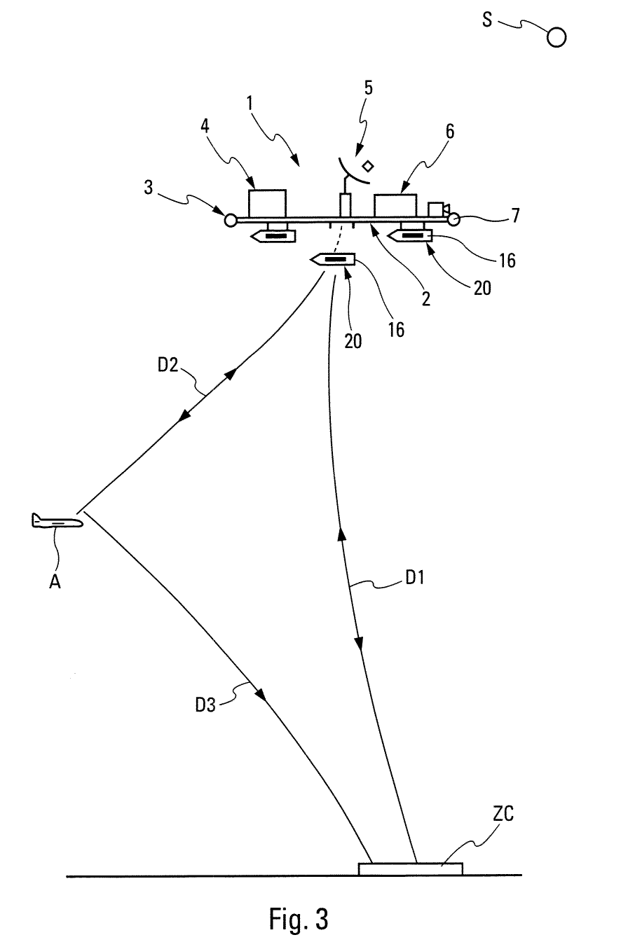

In the second mode, the storing tanks 16 for liquefied hydrogen are present under the shape of flying bodies 20, as shown schematically on FIGS. 2 and 3. Such flying bodies 20 are for instance drones fastened removably under the platform 2 and the aim of which is to carry out motions, either between the platform 2 located in the high atmosphere and a target area ZC on the ground (earth or sea) (motion D1) for emptying the liquefied hydrogen, either between the platform 2 and aircrafts A or other flying devices, operating with hydrogen (motion D2), so as to supply them with fuel. Thus such drones 20 fill two functions, that of tank as such and that of supplying device.

As the apparatus 1 is located in the high atmosphere, the drones 20 loaded with liquefied hydrogen are dropped from the platform and can advantageously glide for moving, under the effect of the acceleration of the gravity and by means of their mobile aerodynamic surfaces, towards the airplane to be supplied or on the earth target area. Naturally, it (they) could be motorized and operate with hydrogen produced by the conversion device of the apparatus. In the case of supplying, once arrived at the vicinity of the airplane to be supplied and via detection means provided on the drone (such as radar, optical or infrared aiming, RF system, differential GPS, etc.), the drone 20 establishes the contact with the airplane A and is connected to the latter using a current pole mechanism or according to a meeting system of the space type. When the transfer of the liquefied hydrogen is performed, the drone 20 leaves the airplane A. It is then able, if it is provided with a hydrogen engine and a supply of hydrogen, to reach back the platform or to go on descending by gliding until it lands (motion D3). It is then reset in a condition for a further use.

As another example, drones could also be used for supplying boats in emergency cases in the sea, and be recovered subsequently or not.

Thus using an available natural source of power (the sun), the all hydrogen apparatus 1 of the present method, system and device is overall and autonomous while producing hydrogen without resulting in pollution nor environment nuisance through its location in the high atmosphere, and dispensing the collected liquefied hydrogen in any target areas located on the ground (vessels, etc.) or flying (airplanes).

1. An apparatus for producing and dispensing hydrogen from water submitted to the action of sun radiation, of the type arranged in altitude, above the cloud layers, and comprising:
a platform;
a controllable sustaining device for said platform in altitude for carrying out the different lifting, descent and level putting phases of the latter;
a water supply associated with said platform;
a device for converting water into its hydrogen and oxygen components, from sun power being received and arranged on said platform; and
processing and storing means for the obtained hydrogen, provided on said platform.
wherein said hydrogen processing and storing means comprise liquefying equipment and tanks containing liquefied hydrogen and in that said tanks of liquefied hydrogen are integrated into flying bodies removably fastened to said platform and designed for reaching a target area so as to dispense the liquefied hydrogen contained in said tanks.

2. The apparatus according to claim 1,
wherein said controllable sustaining device is of the balloon type and comprises at least a gas envelope with a settable varying volume for providing the different operational phases of said platform.

3. The apparatus according to claim 2,
wherein said gas envelope has an O-ring shape so as to be arranged on the periphery of said platform.

4. The apparatus according to claim 2,
wherein said gas envelope is filled by part of the hydrogen being produced in situ by said conversion device.

5. The apparatus according to claim 2,
wherein said gas envelope is filled with helium.

6. The apparatus according to claim 1,
wherein said water converting device is of the cracking type spontaneously dissociating hydrogen and oxygen from water and comprises at least one sun concentrator supplying the power necessary to such a conversion and mounted mobile on said platform so as to constantly and perpendicularly receive sun radiation.

7. The apparatus according to claim 1, wherein said water converting device is of the conversion type for heat emitted by sun radiation in current for obtaining the electrolysis of water of said supply.

8. The apparatus according to claim 7,
wherein said water converting device through electrolysis comprises at least one photovoltaic generator mounted mobile on said platform with an automatic orientation in the direction of the sun, perpendicularly to its radiation.

9. The apparatus according to claim 7,
wherein said water converting device through electrolysis comprises at least one thermal engine.

10. The apparatus according to claim 9,
wherein with said thermal engine a sun concentrator is associated, being oriented in a continuous and automatic way in the direction of the sun, and in the focus of which said engine is located.

11. The apparatus according to claim 9,
wherein said thermal engine is a Stirling engine or a thermo-acoustic engine.

12. The apparatus according to claim 1, wherein said liquefied hydrogen tanks are arranged on said platform and are protected from sun radiation by a mask forming equipment and generating shadow.

13. The apparatus according to claim 1, wherein said liquefied hydrogen tanks are arranged under said platform so as to be protected from sun radiation.

14. The apparatus according to claim 1, wherein said flying bodies are drones carrying out their descent phase to the target area by gliding, with a terminal guidance equipment towards said target area, and their lifting phase back to said platform being propelled by an engine provided in each one of them and operating with hydrogen.

15. The apparatus according to claim 1,
further comprising an attitude and position controlling device for said platform being located in the atmosphere.

16. The apparatus according to claim 1,
further comprising an equipment for collecting water particles from the clouds, so as to fill said water supply.

17. The apparatus according to claim 1,
further comprising means for processing and storing the oxygen obtained through the dissociation of water into its components, said means comprising at least one liquefying equipment and tanks containing the liquefied oxygen.
